(19) United States
(12) Patent Application Publication
(10) Pub. No.: US 2011/0287642 A1
(43) Pub. Date: Nov. 24, 2011

(54) CABLE CONNECTOR ASSEMBLY EMPLOYING SEPARATE INTER CONNECTING CONDUCTORS AND METHOD FOR ASSEMBLING THE SAME

(75) Inventors: CHIEN-CHIUNG WANG, New Taipei (TW); QING-MAN ZHU, Kunshan (CN); XUE-LIANG ZHANG, Kunshan (CN)

(73) Assignee: HON HAI PRECISION INDUSTRY CO., LTD., New Taipei (TW)

(21) Appl. No.: 13/110,042

(22) Filed: May 18, 2011

(30) Foreign Application Priority Data
May 18, 2010 (TW) 99115760

(51) Int. Cl. H01R 12/00; H01R 43/00; H01R 13/40

(52) U.S. Cl. 439/83; 439/586; 29/857

(57) ABSTRACT

A cable connector assembly (1) includes a connector (100) and a cable (200) has an end mounted to the connector. The cable includes at least one inner conductor (210). At least one connecting conductors (300) has a first end (310) inserting into the at least one inner conductor and electrically connecting with the at least one inner conductor, and an opposite second end (320) electrically connecting with the connector to establish an electrical connection between the connector and the cable for signal transmission.

### BACKGROUND OF THE INVENTION

1. Field of the Invention

The present invention relates to a cable connector assembly, and more particularly to a structure for connecting a cable thereof with a connector thereof

2. Description of Related Arts

U.S. Pat. No. 6,619,987, issued on Sep. 16, 2003, to Kumamoto et al. discloses a related art. According to the disclosure, a cable connector assembly comprises a connector comprising a connector body and a connecting assembly received in the connector body, and a cable connected to the connector. The connecting assembly has a mating end for mating with a mating connector and a rear end opposite to the mating end. The cable comprises a plurality of inner wires soldered on the rear end so that an electrical connection is made between the connector and the cable. Before the inner wire of the cable is soldered on the connector, it is necessary to strip the jacket of the cable and to arrange the inner wires.

U.S. Pat. No. 5,402,088, issued on Mar. 28, 1995, to Pierro et al. discloses a related art. According to the disclosure, a coaxial-to-coplanar waveguide connector is used for interconnecting stripline compatible devices utilizing coaxial cable. The connector is formed at the end of a length of coaxial cable embedded within a circuit board. The connector generally has a substantially semi-circular connection section. The connection section includes a conductor partly surrounded by an electrically insulative dielectric which is partly surrounded by a shield. An electrically conductive sheet is used to couple the shield to a ground plane of the circuit board.

U.S. Pat. No. 6,350,146, issued on Feb. 26, 2002, to Su discloses a related art. According to the disclosure, a cable connector assembly includes a cable connector and a cable. The cable connector includes a connector body, a retention frame, a retention body, and a conductive body. Each wire of the cable includes an insulation layer surrounding a plurality of metal conductor threads therein. The retention body defines a plurality of tapered passageways therethrough. The connector body has an insulative housing retaining a plurality of contacts. Each contact is formed with a tapered portion for piercing into the passageway along a lengthwise direction of the wire to engage with and expand the wire. The insulation is expanded by the tapered portion of the contact to securely engage with the retention body.

Hence, an improved cable connector assembly is desired to offer advantages over the related art.

### SUMMARY OF THE INVENTION

An object of the present invention is to provide a cable connector assembly having a connecting conductor connected between the inner conductor and the cable.

To achieve the above-mentioned object, a cable connector assembly comprises a connector and a cable having an end connecting with the connector. The cable comprises at least one inner conductor. At least one connecting conductors has a first end for inserting into the at least one inner conductor, and an opposite second end for electrically connecting with the connector such that an electrical connection suitable for signal communication is made between the connector and the cable.

According to the present invention, the cable connector assembly has at least one connecting conductor having a first end for inserting into the cable and an opposite end for connecting to the connector such that an electrical connection is made between the connector and the cable. It is unnecessary to strip the jacket of the cable and to coordinate the inner wires. Therefore, the cost of assembling the cable to the connector is reduced.

### BRIEF DESCRIPTION OF THE DRAWING

FIG. 1 is a perspective view of a cable connector assembly in accordance with the present invention;

FIG. 2 is a cross-sectional view of the cable connector assembly takes along line 2-2 in FIG. 1;

FIG. 3 is an exploded view of the cable connector assembly as shown in FIG. 1;

FIG. 4 is a perspective view showing the cable connected with the inner PCB of the cable connector assembly as shown in FIG. 1;

FIG. 5 is another perspective view showing the cable connected with the inner PCB of the cable connector assembly as shown in FIG. 1;

FIG. 6 is an enlarged view showing the cable connected with the inner PCB of the cable connector assembly as shown in FIG. 4;

FIG. 7 is view similar to FIG. 5 but showing the cable not yet connected; and

FIG. 8 is an enlarged view of the circled portion in FIG. 7.

### DETAILED DESCRIPTION OF THE PREFERRED EMBODIMENT

Reference will now be made in detail to a preferred embodiment of the present invention.

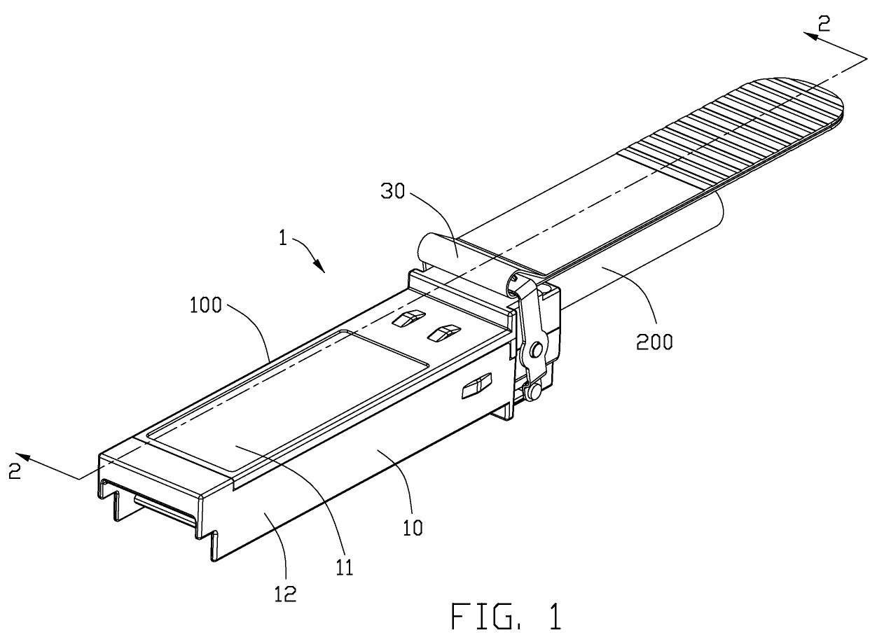

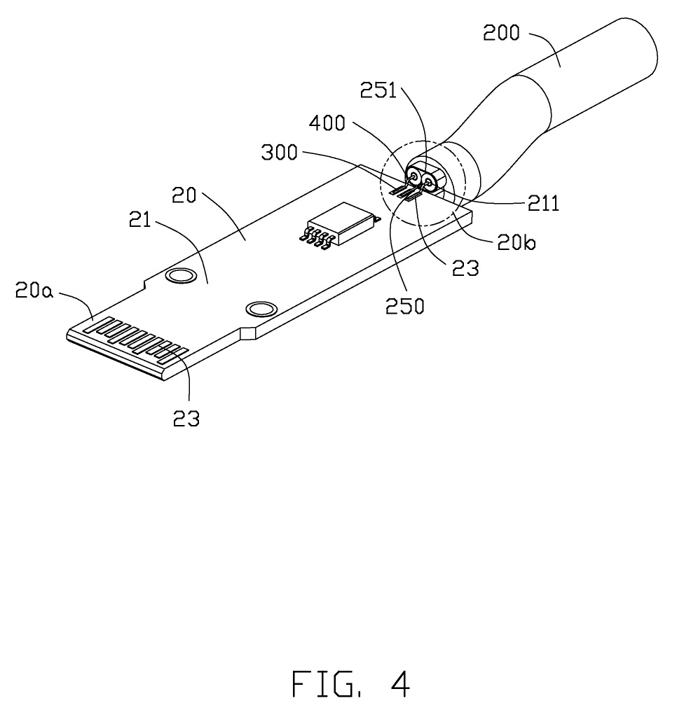

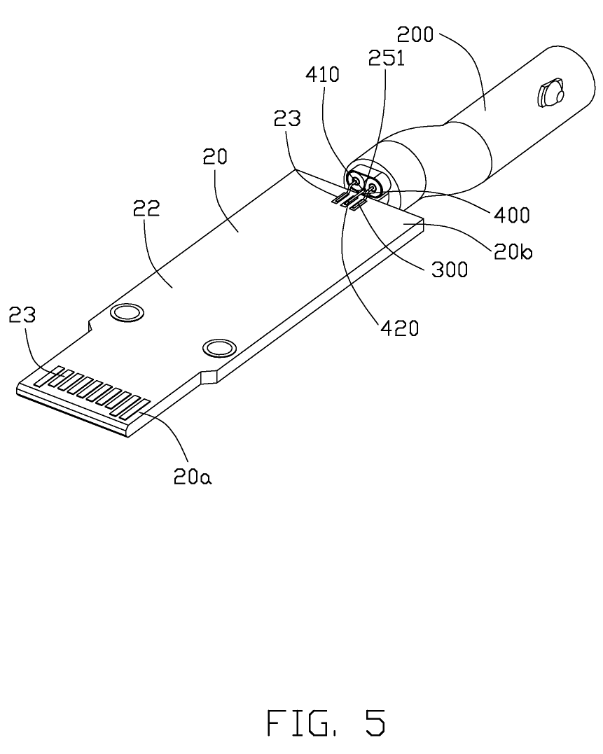

Referring to FIGS. 1 to 5, a cable connector assembly comprises a connector 100, and a cable 200 having an end mounted to the connector 100.

Referring to FIGS. 1 to 5, the connector 100 comprises a connector body 10, an inner PCB 20 (Printed Circuit Board) received in the connector body 10, and optionally a de-latching assembly 30 mounted on the connector body 10.

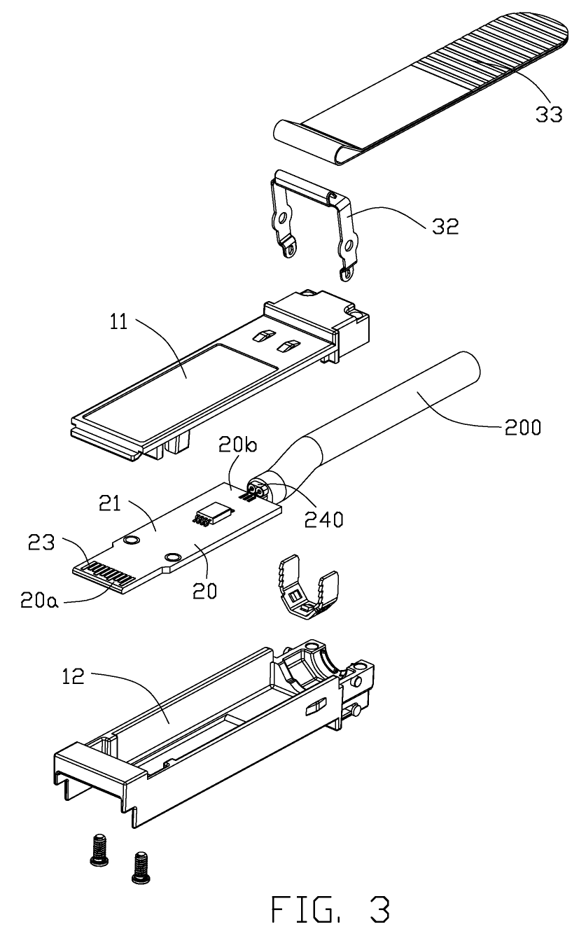

Referring to FIGS. 1 and 3, the connector body 10 comprises a base 12 and a cover 11 fastened to the base 12. The base 12 and the cover 11 cooperate to form a receiving room 13 to receive the inner PCB 20.

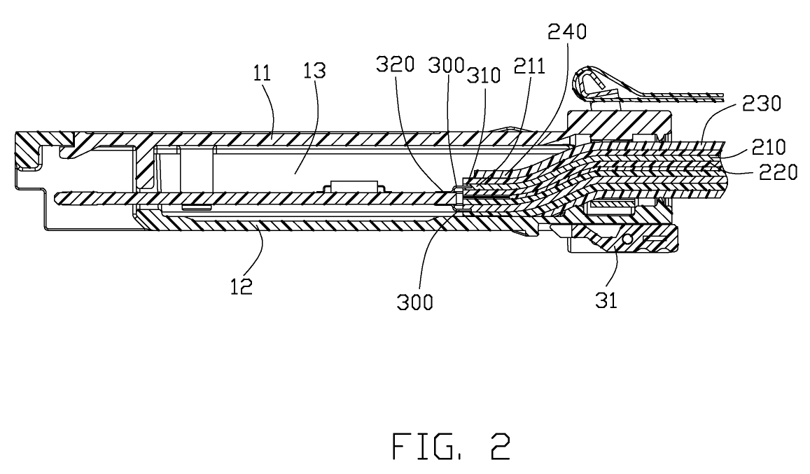

Referring to FIGS. 2-5, the inner PCB 20 comprises a mating end 20a for mating with a mating connector, a rear end 20b opposite to the mating end for electrically connecting with the cable 200, and a top and a bottom surfaces 21, 22. A plurality of conductive pads 23 are disposed on the top and bottom surfaces adjacent to the mating end 20a and rear end 20b.

Referring to FIGS. 2 and 3, the de-latching assembly 30 comprises a slider member 31 mounted on the bottom surface of the base 12, a pivot member 32 pivotally mounted on the connector body 10 and having a first end connecting with the slider member 31 and an opposite second end, and a pulling member 33 connecting with the second end of the pivot member 32.

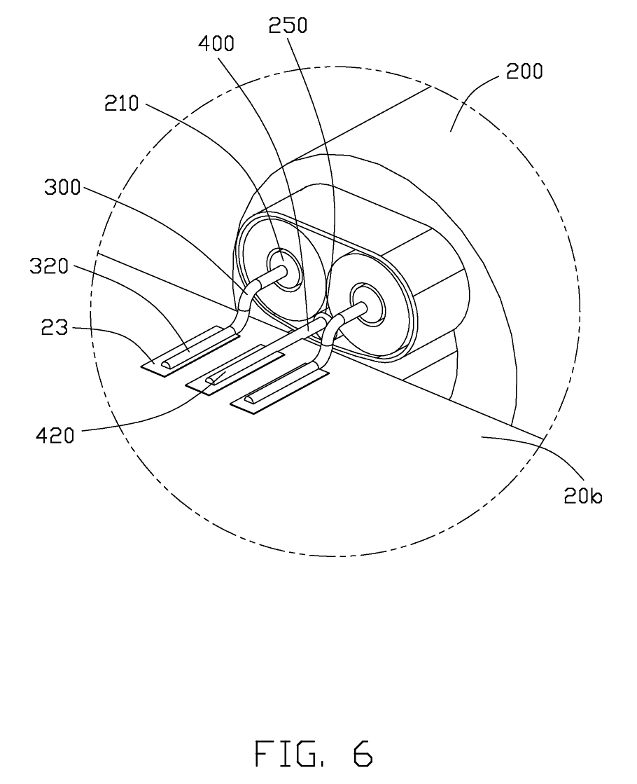

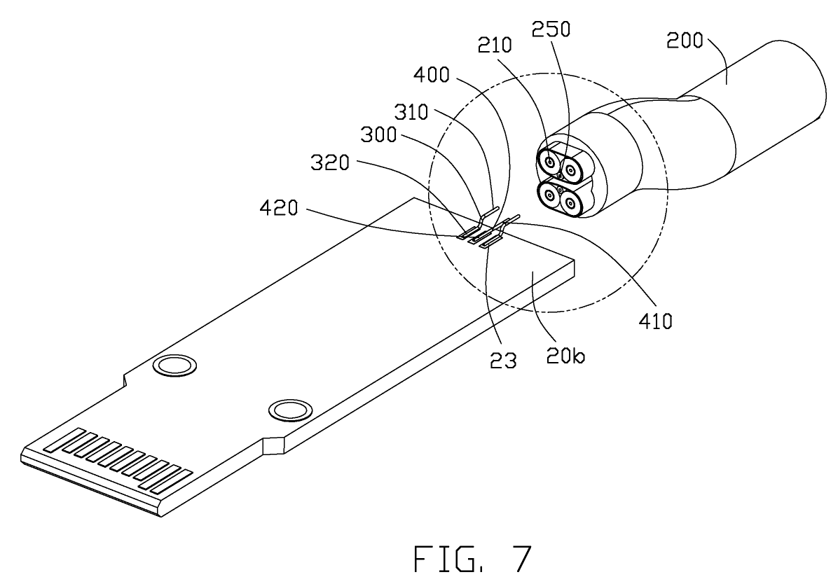

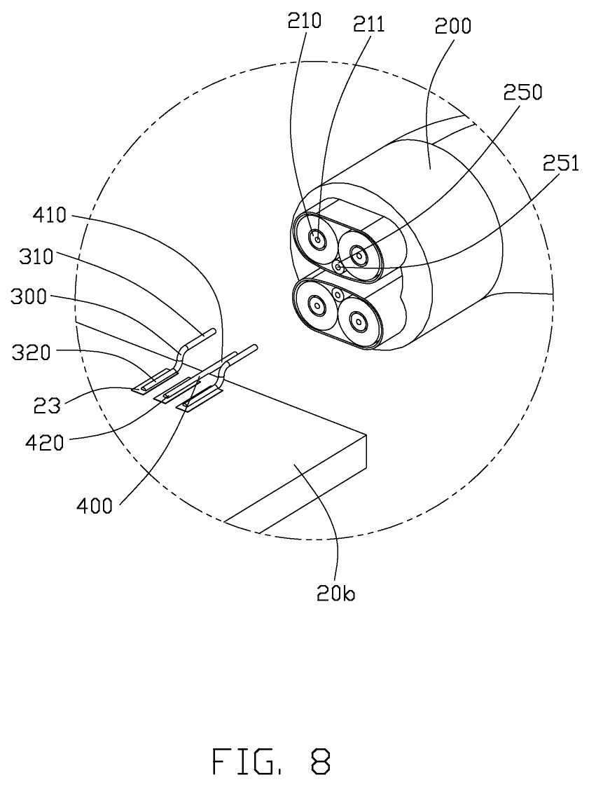

Referring to FIGS. 2 to 8, the cable 200 comprises six inner conductors 210, 250 having four signal conductors 210 and two ground conductors 250. The six inner conductors 210, 250 are divided into two inner conductor assemblies each having a pair of signal conductors 210 of the four signal conductors 210 and one ground conductor 250 of the two ground conductors 250. Each inner signal conductor 210 of the cable 200 is shrouded by an insulative layer 220. Each inner ground conductor 250 of the cable 200 is disposed outside of the pair of inner signal conductors of corresponding inner conductor assembly. Each of the inner conductor assemblies is enclosed by an aluminum foil or shielding layer 240. Each of the inner ground conductors is electrically connected with the corresponding layer 240. The cable 200 also has a mesh layer (not shown) enclosing the aluminum foil layers 240 and a jacket 230 enclosing the mesh layer.

As an option, any number of inner conductors could be used. For example, the cable can be a RF (Radio Frequency) coaxial cable having only one inner signal conductor. The only one inner signal conductor may, moreover, comprise a signal conductive wire or consists of a number of conductive wires.

Referring to FIGS. 2 to 8, in the first embodiment shown, each of the signal conductors 210 and the ground conductors 250 is a single conductor. Each of the inner signal conductors 210 defines a mounting hole 211 extending from the end of the cable 200 along its own axis. Each of the inner ground conductors 250 defines a mounting hole 251 extending from the end of the cable 200 along its own axis. In another second embodiment (not shown), the signal conductor 210 or the ground conductor 250 may be composed of a cluster of conductive wires or wire strands. In such design there is no need to separately make a mounting hole for the signal conductor or the ground conductor. Instead, the gap or void space between adjacent wires or wire strands provides a mounting hole ready for insertion into by a connecting conductor 300 to be described later.

Referring to FIGS. 2 to 8, each of the signal connecting conductors 300 has a first end 310 inserting into the corresponding mounting hole 211 of the inner signal conductor 210, and a second end 320 opposite to the first end 310 electrically connecting with the rear end 20b of the inner PCB 20. The second ends 320 of the signal connecting conductors 300 are soldered on the conductive pads 23 of the top and the bottom surfaces 21, 22 adjacent to the rear end 20a of the PCB 20. Therefore, a plurality of signal channels are made between the cable 200 and the connector 100. Each of the plurality of ground connection conductors 400 has a first end 410 inserting into the corresponding mating hole 251 of the inner ground conductor 250, and a second end 420 opposite to the first end 410 electrically connected with the rear end 20b of the inner PCB 20. In this embodiment, the second ends 420 of the ground connection conductor 400 are soldered on the conductive pads 23 of the top and the bottom surfaces 21, 22 adjacent to the rear end 20a of the PCB 20. Therefore, a plurality of ground signal channels are made between the cable 200 and the connector 100. The inner signal conductors 210 and the ground conductor 250 of one inner conductor assembly are electrically connected with the top surface 21 of the inner PCB 20, and the inner signal conductors 210 and the ground conductor 250 of the other inner conductor assembly are connected with bottom surface 22 of the inner PCB 20.

In second embodiment, each of the first ends 310 of the signal connecting conductors 300 is directly inserted into the corresponding inner signal conductor 210 composed by a number of conductive wires. Each of the first ends of the ground connection conductors 400 is directly insert into the corresponding inner ground conductor 250 composed by a number of conductive wires. Therefore, a plurality of signal channels or a plurality of ground signal channels are made between the cable 200 and the connector 100.

Referring to FIGS. 2 to 8, in first embodiment, the steps of assembly the cable connector assembly may includes: a) cutting the end of the cable 200 to form a planar end surface; b) making a mounting hole 211, 251 on corresponding inner signal conductor 210 and inner ground conductor 250 along axial direction of the corresponding inner signal conductor 210 and the inner ground conductor 250; c) inserting the first ends 310, 410 of the signal connecting conductors 300 and the ground connecting conductors 400 into the corresponding mounting holes 211, 251 of the inner signal conductor 210 and the inner ground conductor 250; d) soldering the second ends 320, 420 of the signal connecting conductors 300 and the ground connecting conductors 400 on the conductive pads 23 of the top and the bottom surfaces 21, 22 adjacent to the rear end 20a of the PCB 20.

In second embodiment, it is unnecessary to making the mounting holes 211, 251 on corresponding inner signal conductors 210 or inner ground conductors 250 as each of the inner signal conductor 210 or the ground conductor 250 is composed by a number of conductive wires. When each of the first ends 310, 410 of the signal connecting conductors 300 and the ground connecting conductors 400 is directly inserted into the corresponding inner signal conductor 210 or inner ground conductor 250, the conductive wires of the inner signal conductor 210 or inner ground conductor 250 will contact with the first ends 310, 410 and make an electrically connecting between them.

It is unnecessary to strip the jacket 230 of the cable 200 and to coordinate the inner wires 210 before the inner wire 210 of the cable 200 is soldered on the connector 100. Therefore, the time of assembling the cable 200 to the connector 100 is saved. The cost of assembling the cable 200 to the connector 100 is saved.

It is to be understood, however, that even though numerous characteristics and advanarmes of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cable connector assembly comprising:
a connector;
a cable having an end mounted to the connector, said cable comprising at least one inner conductor; and
at least one connecting conductor having a first end inserting into the at least one inner conductor and electrically connecting with the at least one inner conductor, and an opposite second end electrically connecting with the connector to establish an electrical connection between the connector and the cable for signal transmission.

2. The cable connector assembly as recited in claim 1, wherein the at least one inner conductor defines a mounting hole extending from the end of the cable along an axial line of the at least one inner conductor, the first end of the at least one connecting conductor being inserted into the mounting hole.

3. The cable connector assembly as recited in claim 2, wherein there are six inner conductors comprising four signal conductors and two ground conductors, the six inner conductors divided into two inner conductor assemblies, each inner conductor assembly comprising a pair of signal conductors of the four signal conductors and a ground conductor of the two ground conductors.

4. The cable connector assembly as recited in claim 3, wherein there are six connecting conductors connecting corresponding signal conductors and corresponding ground conductors to the connector.

5. The cable connector assembly as recited in claim 4, wherein each of the signal conductors of the inner conductor assemblies is shrouded by an insulative layer, the ground conductors disposed outside of the insulative layers.

6. The cable connector assembly as recited in claim 5, wherein said connector comprises an inner PCB (printed circuit board) having a mating end for mating with a mating connector and a rear end opposite to the mating end for electrically connecting with the second ends of the connecting conductors.

7. The cable connector assembly as recited in claim 6, wherein the two inner conductor assemblies are connected with opposite sides of the inner PCB.

8. The cable connector assembly as recited in claim 7, wherein said inner PCB comprises a plurality of conductive pads, the second ends of the connecting conductors being soldered on the conductive pads, respectively.

9. The cable connector assembly as recited in claim 3, wherein each of the inner conductor assemblies is enclosed by a shielding layer.

10. The cable connector assembly as recited in claim 9, wherein each of the ground conductors of the inner conductor assemblies is electrically connected with the shielding layer.

11. The cable connector assembly as recited in claim 1, wherein said connector comprises a base and a cover assembled to the base.

12. The cable connector assembly as recited in claim 1, wherein the at least one inner conductor is composed by a plurality of conductive wires, the first end of the at least one connecting conductor being inserted into the at least one inner conductor and electrically connecting with the conductive wires.

13. A method for assembling a cable connector assembly, comprising the steps of:
a) providing a connector;
b) preparing a cable having an end for being mounted to the connector and comprising at least one inner conductors;
c) cutting the end of the cable to form a planar end surface; and
d) inserting a first end of a connecting conductor into the at least one inner conductor from the planar end surface to electrically connect with the at least one inner conductor, and connecting an opposite second end of the connecting conductor with the connector to establish an electrical connection between the connector and the cable for signal transmission.

14. An electrical cable connector comprising:
a housing defining a receiving space;
a printed circuit board received in the receiving space;
a plurality of mating pads formed on a front region of the printed circuit board;
a cable located around a rear side of the printed circuit board and defining therein a plurality of wires extending along an axial direction;
a plurality of conductor each of which is stiff enough to have one end soldering upon a rear region of the printed circuit board, and the other end piercing into a corresponding wire along the axial direction to establish electrical connection between the printed circuit board and the cable.

15. The electrical cable connector as claimed in claim 14, wherein a front end of the cable is intimately located behind a rear edge of the printed circuit board.

16. The electrical cable connector as claimed in claim 15, wherein the cable is essentially symmetrically located along a mid-level of the printed circuit board.
